(19) United States
(12) Patent Application Publication
(10) Pub. No.: US 2023/0244207 A1
(43) Pub. Date: Aug. 3, 2023

(54) METHOD AND DEVICE FOR THE AUTOMATIC DETERMINATION OF MACHINING PARAMETERS FOR A MACHINING PROCESS

(71) Applicant: Fronius International GmbH, Pettenbach (AT)

(72) Inventors: Helmut ENNSBRUNNER, Pettenbach (AT); Daniel ANGERMAYR, Pettenbach (AT)

(73) Assignee: Fronius International GmbH, Pettenbach (AT)

(21) Appl. No.: 17/927,430

(22) PCT Filed: Jan. 26, 2022
(86) PCT No.: PCT/EP2022/051661

§ 371 Date: Nov. 28, 2022

(30) Foreign Application Priority Data
Jan. 27, 2021 (EP) 21153696.6

(51) Int. Cl. G05B 19/402

(52) U.S. Cl. CPC G05B 19/402; G05B 2219/35524

(57) ABSTRACT

A method automatically determines machining parameters for a machining process, in which a machining head is guided along a machining path over at least one workpiece to be machined, and, depending on the respective position along the machining path, certain machining parameters are selected from stored machining parameters on the basis of predefined conditions for machining the at least one workpiece, and a device machines a workpiece. The limit values for the machining parameters are determined during the machining process to be performed, and new machining parameters for the machining process to be performed are specified by taking these limit values into consideration.

The invention relates to a method for the automatic determination of machining parameters for a machining process, in which a machining head is guided along a machining path over at least one workpiece to be machined, and, depending on the respective position along the machining path, certain machining parameters are selected from stored machining parameters on the basis of predefined conditions for machining the at least one workpiece.

The invention further relates to a device for machining a workpiece by means of a machining head along a machining path with certain machining parameters.

Machining process include in particular joining processes, such as, for example, welding or soldering processes, in which workpieces are connected to one another or workpieces are coated, but also surface treatment processes, such as, for example, plasma treatment processes, in which workpieces are treated or cleaned, respectively, by means of plasma, in order to prepare them for subsequent machining. For example, the surface of workpieces can be treated by means of plasma prior to the varnishing in order to free the surface from residues and/or to improve the adhesion of the varnish coat. Processes, in which workpieces are cut, are also conceivable.

Methods are known, which automatically determine machining parameters for machining processes for certain tasks, in that ideal machining parameters are used, which were determined beforehand by experts for this task. The user of the machining process thus no longer has to have expert knowledge, without the quality of the machining result suffering. The predefined conditions, on the basis of which certain machining parameters are selected from stored machining parameters for performing the respective machining process, are dependent on the respective machining task, and have to be defined by corresponding experts prior to the machining process or can also be determined during the machining process. In addition to the mechanical properties of the weld seam, it can also be important, for example, in the case of a visible weld seam that the weld seam is formed to be as narrow and even as possible, whereas the strength of the connection and thus a sufficient penetration depth can be more important in the case of a non-visible weld seam. The conditions for selecting the machining parameters for the machining process will thus be different, depending on the respective task, and will be defined accordingly.

For example, EP 3 484 650 B1 describes a method for the determination of welding parameters for a welding process, in which welding processes can be parameterized without the intervention of experts along any welding paths, in that the welding parameters for the respective welding process are specified on the basis of ideal welding parameters, which were recorded and stored under test conditions on test workpieces, by interpolation. The welding parameters for certain workpiece geometries can thus be combined automatically from previously defined ideal welding parameters, without the welder having to take action in this respect. The ideal welding parameters were thereby specified on the test workpieces for a certain welding task, which is to be solved.

EP 3 566 806 A1 describes a welding process, in which optimal welding parameters, which were determined on the basis of test welds on the test workpieces, are used automatically for the welding process in order to attain certain quality criteria. The determination of the optimal welding parameters for the respective welding task takes place via the optimum of a calculated quality functional via the respective optimal welding parameters of the test welds.

DE 10 2009 020 246 A1 describes a method and a machine for chip forming machining, wherein certain machining parameters are selected depending on the respective position along the machining path. By analyzing the vibration behavior of the workpiece, interferences can be recognized, and machining parameters for subsequent machining processes on identical workpieces can be corrected or regulated, respectively.

EP 3 176 658 A1 described a method for controlling a machine tool, wherein the control unit is formed to perform a workpiece-specific machining process. It is possible to monitor the adherence of definable limit values for process parameters, and to optionally output a warning or to stop the machining.

In the case of known methods or devices of the type at hand, it is not taken into consideration that ideal machining parameters cannot always be realized. In the case of a robot welding system, for example, certain angles of attack of the welding torch cannot always be realized due to the geometry of the workpiece, of the clamping devices, etc., or the desired machining speed or welding speed cannot always be reached. A long hose package or the installation thereof can also have the result that certain ideal welding parameters cannot be realized.

The object of the present invention is to create an above-mentioned method for the automatic determination of machining parameters for a machining process and a corresponding machining device, by means of which machining parameters can be adapted even better to the respective conditions, so that optimal machining results and thus the highest machining qualities can be attained when machining the workpieces even without expert knowledge of the user. Disadvantages of known methods and devices are to be avoided or at least reduced.

The object according to the invention is solved in that limit values for the machining parameters are determined and preferably stored during the machining process to be performed, and new machining parameters for the machining process to be performed are specified by taking these limit values into consideration. According to the invention, the method for the automatic determination of new machining parameters is expanded by an additional dimension or option of taking limit values for machining parameters into consideration. The level of automatization of the machining process can thus be increased even further in that limit values of this type for machining parameters are taken into consideration during the automatic determination of the new machining parameters. The limit values for the machining parameters can be determined in real terms prior to or during the machining process or also virtually by means of simulation. For example, the limit values for machining parameters are minimal and/or maximal control variables, respectively, of certain machining parameters, which can also vary along the machining path because they are dependent, for example, on the workpiece geometry, geometry and respective position of the machining device or of the machining robot, etc. If certain limit values for certain machining parameters are determined, these limit values are then taken into consideration during the determination of the machining parameters, and new machining parameters are specified. The new machining parameters can, for example, correspond to the respective limit value for the machining parameter or can be replaced by another machining parameter or several machining parameters, respectively, so that the machining process can be performed without quality losses for the machining result and without exceeding or falling below limit values for the machining parameters. If the limit values for machining parameters are not reached or approached, the machining process is continued with the certain machining parameters as new machining parameters. If limit values are reached or approached, changed machining parameters are specified as new machining parameters, and the machining process is performed without limit value violation. To take the limit values for machining parameters into consideration, they have to be determined or algorithms for the determination thereof have to be stored. If a limit value of a certain machining parameter appears at a certain position of the machining path, a consideration of the limit value can already be necessary upstream of this position along the machining path. If, for example, a clamping device for the workpiece makes a certain angle of attack of the machining head impossible at the location of the clamping device, the angle of attack of the machining head will already be changed slightly upstream of the clamping device, and will also be brought into the optimal position again slightly downstream from the clamping device. In the region of the clamping device, the machining process is thus performed with the new machining parameters, which take the limit values into consideration. Farther away from the clamping device, the new machining parameters of the machining process correspond to the certain machining parameters. In the case of a welding method as machining process, for example limit values for the welding current, the welding performance, the rise rate of the welding current, or the welding voltage can be present, which are specified by the welding current source or which can also result from the position of the hose package. Limit values for the angle of attack or of the operating angle of the welding torch as well as the rotation of the hose package can be due to the geometry of the workpiece. At least an upper limit value for the conveying speed of the welding wire will also be defined by the feed unit for the welding wire.

Prior to the selection of the certain machining parameters for the machining process to be performed, ideal machining parameters are preferably determined and stored by means of test machining processes on several test workpieces along test machining paths, in each case with a certain position and arrangement of the test workpieces, and the certain machining parameters are determined at the respective position along the machining path for the machining process to be performed from the stored ideal machining parameters for the certain positions and arrangements of the test workpieces. The position and arrangement of the test workpieces and also the current position and arrangement of the workpiece can be set with respect to the gravity acceleration vector and a certain tangential vector of the test machining path or machining path, respectively. This represents a preferred method for the determination of machining parameters for a machining process, as it is described, for example, in EP 3 484 650 B1, which has already been mentioned above, for a welding process.

The certain machining parameters at the respective position along the machining path for the machining process to be performed depending on the current position and arrangement of the at least one workpiece can be determined, for example, easily and quickly by means of interpolation of the stored ideal machining parameters. The welding parameters can be determined, for example, from stored values for the welding process in the case of certain angles along the periphery of the pipe during the welding of a pipe, depending on the position of the welding torch with respect to the pipe, and can be interpolated in-between.

According to a feature of the invention, the limit values for the machining parameters can be input and can preferably be stored. This represents the option, in which limit values are defined and input by the user of the machining process, so that they can be taken into consideration during the determination of the machining parameters and specification of the new machining parameters. It goes without saying that the input of the limit values can also be performed by a superordinate point and can be transmitted to the machining device. The limit values can furthermore also be determined by means of a machining robot, the workpiece, the machining process, etc., and can also be specified or input, respectively, automatically. The limit values can be stored in any memories, for example in the welding current source, databases, etc.

Alternatively or additionally to the input, the limit values for the machining parameters can also be determined automatically and can preferably be stored prior to performing the machining process. The machining process can be run through, for example, by calculation or virtually, respectively, along the machining path, and it can be determined thereby, which machining parameters are limited in what way at which positions along the machining path. In the case of the so-called “offline” method, the limit values are determined prior to the machining process and are preferably stored for the later consideration during the machining process. Suboptimal machining parameters can be detected thereby, and alternative machining parameters, which are better suited for the machining, can be found and can be specified as new machining parameters for the machining process to be performed. These alternative machining parameters can be determined, for example, from test welds, in which limit values are taken into consideration.

Alternatively or additionally to the two above-mentioned methods, the limit values for the machining parameters can also be determined automatically while performing the machining process. The limit values of the machining parameters are thereby determined and taken into consideration in real time or quasi real time with small delays during the machining process. The frequency of the determination along the machining path is limited by the respective computing power. The machining speed in the case of the so-called “online” method might therefore possibly he limited, whereas the “offline” method or the simulation, respectively, can be performed more quickly. For documentation purposes, the limit values for the machining parameters determined while performing the machining process can also be stored depending on the position along the machining path. However, the storing of the limit values is not necessary in the case of the “online” method.

In addition to the limit values for the machining parameters, alternative machining parameters can be stored, which are specified as new machining parameters for the machining process to be performed when reaching the limit values. In addition to the optimal machining parameters, the alternative machining parameters are alternatives for these optimal machining parameters for the machining process by mainlining the limit values for the machining parameters, which are specified as new machining parameters when reaching the limit values. In the case of a welding process, it can be necessary, for example, to change several welding parameters when the operating angle of the welding torch to the workpiece cannot be maintained any longer.

According to a further feature of the invention, a warning can be output and/or information can be stored, respectively, when a certain machining parameter for the machining process to be performed approaches a limit value for the machining parameters or reaches a limit value for the machining parameters. The approaching or reaching of limit values for machining parameters can be important for the user during the machining process or the subsequent quality control of the workpiece to be machined. How early a warning is output or information is stored before reaching a limit value, thus when approaching a limit value, depends on the respective machining parameter and the respective conditions of the machining process and can vary strongly. For example, the warning can be output when 90% of a maximal angle are reached as factor of a limit value or when 10° are reached before a maximum angle as absolute value before the limit value. The warning during the machining process can take place, for example, acoustically, optically, or also mechanically directly during the machining process or to a master control center.

When approaching or reaching at least one limit value for a machining parameter as certain machining parameter for the machining process to be performed, this at least one limit value can be selected for a machining parameter or approached limit value for a machining parameter or stored alternative machining parameter as new machining parameter for the machining process to be performed. This method represents a simple consideration of the limit values for machining parameters during the automatic determination of machining parameters for a machining process, in that the values for the respective machining parameters are simply limited with the limit values. For some, simple machining processes, this can be sufficient in order to not reach machining limits and to nonetheless be able to perform the machining process without interruption. For example, a surface treatment process can be limited to a certain machining speed by means of a plasma jet, in order to securely attain the machining result, for example the cleaning of the surface along the machining path. During a welding process, the angle of attack of the welding torch can be limited, for example, to the maximally possible angle of attack, thus the upper limit value of this machining parameter, and the other welding parameters can be adapted to this set angle of attack. When reaching a limit value for a machining parameter, however, a more complex change of several machining parameters as new machining parameters will be necessary in many cases for the machining process to be performed.

When selecting the certain machining parameters for the machining process to be performed, the limit values for the machining parameters are advantageously taken into consideration prior to the machining process. The new machining parameters are thereby specified “offline” prior to performing the machining process, and are optionally also subjected to a test beforehand. This can take place in real terms or computationally or virtually, respectively.

The machining process to be performed can then be simulated with the certain machining parameters, and the new machining parameters can be specified for the machining process to be performed before the machining process is actually performed.

In the alternative, the stored limit values for the machining parameters can also be taken into consideration during the machining process when selecting the certain machining parameters for the machining process to be performed, and the new machining parameters for the machining process to be performed can be specified. The new machining parameters are thus specified “online” thereby during the machining process.

To prevent that workpieces are machined incorrectly, the machining process can also be stopped when the specified new machining parameters differ from the certain machining parameters by a predefined factor and/or by a predefined absolute value, respectively, without taking limit values into consideration. A safety barrier can be inserted thereby in order to prevent waste or workpieces or in order to be able to influence the specified new machining parameters once again prior to performing the machining process, respectively.

When the specified new machining parameters deviate from the certain machining parameters by the predefined factor and/or by the predefined absolute value, respectively, a warning can thereby also be output to the user of the machining device or a master control center without taking limit values into consideration, and/or information can be stored for documentation purposes, respectively.

The object according to the invention is likewise solved by means of an above-mentioned device for machining a workpiece by means of a machining head along a machining path with certain machining parameters, which is configured for performing the above-mentioned method. With regard to the advantages, which can be attained thereby, reference is made to the above description of the method for machining a workpiece. The device can be upgraded easily to carry out the method according to the invention by means of possible upgrading of components, which are already present, such as a control device or the like. The significant process-related features can be implemented by software.

The present invention will be described in more detail on the basis of the enclosed drawings, in which:

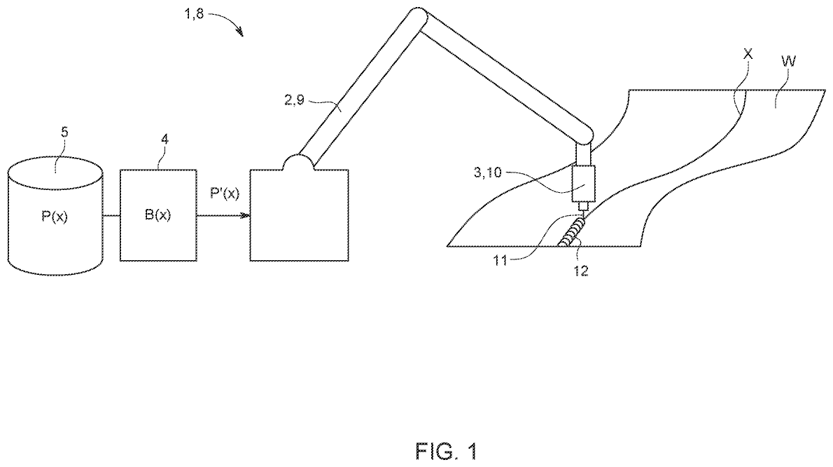

FIG. 1 shows a schematic illustration of a machining device for performing a method for the automatic determination of machining parameters for a machining process according to the prior art;

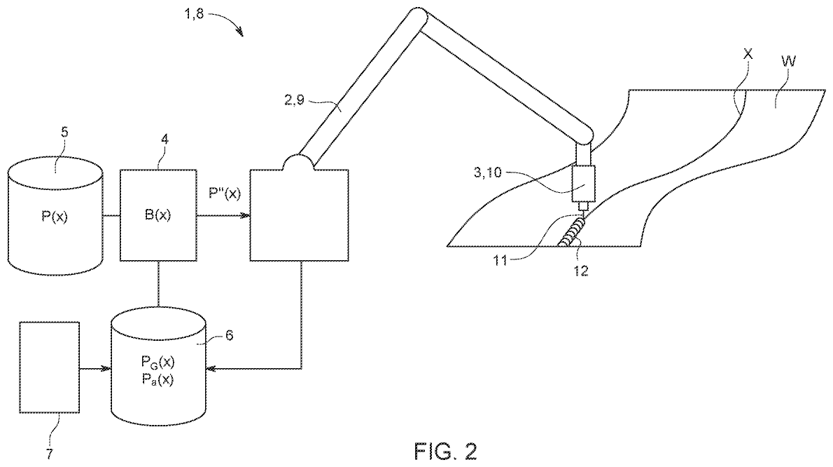

FIG. 2 shows a schematic illustration of a machining device for performing a method according to the invention for the automatic determination of machining parameters for a machining process by taking limit values for the machining parameters into consideration;

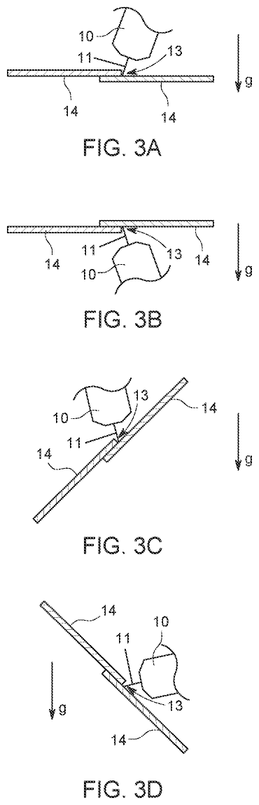

FIG. 3A to 3D show test workpieces comprising test machining paths in various positions with respect to the gravity acceleration vector for the determination of ideal machining parameters;

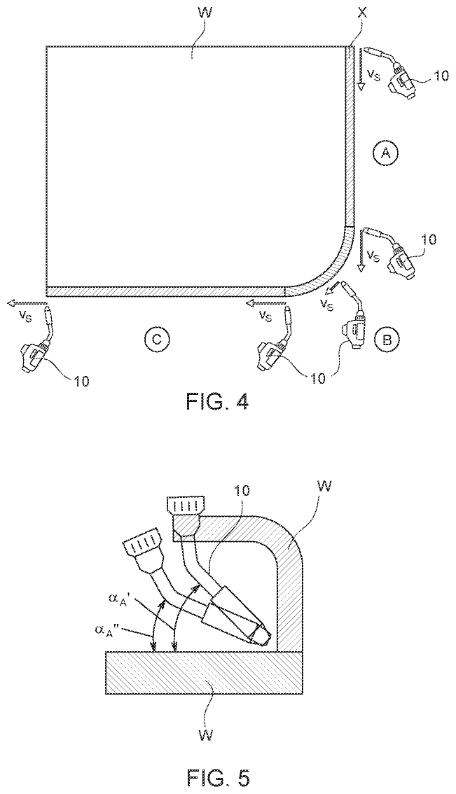

FIG. 4 shows an exemplary embodiment of the specification of new machining parameters on the basis of a welding process in consideration of limit values of the welding speed; and

FIG. 5 shows a further exemplary embodiment of the specification of new machining parameters on the basis of a welding process by taking limit values of the angle of attack of the welding torch to the workpiece into consideration.

FIG. 1 shows a schematic illustration of a machining device 1 for performing a method for the automatic determination of certain machining parameters P′(x) for a machining process BP according to the prior art. The machining device 1 includes a machining robot 2, to which a machining head 3, for example a welding torch 10, is fastened. During the machining process BP, the machining head 3 is guided along a machining path X over at least one workpiece W to be machined. To machine the workpiece W, certain machining parameters P′(x) are selected on the basis of predetermined conditions B(x) from a plurality of possible machining parameters P(x), which are stored, for example, in a memory 5, depending on the respective position x along the machining path X, by means of which machining parameters the workpiece W is machined in order to attain a desired machining result. The respective condition B(x), which depends essentially on the respective machining task, provides the control device 4 of the machining device 1 with corresponding information, on the basis of which the certain machining parameters P′(x) are selected from the stored machining parameters P(x).

The machining device 1 can be, for example, a welding device 8 for performing a joining process or coating process on a workpiece W. A welding torch 10 is thereby fastened by means of a consumable welding wire 11 to a welding robot 9, by means of which two or several workpieces W can be connected to one another, or a coating can be applied to a workpiece W. In this case, the result of the machining process BP is a weld seam 12 between two or several workpieces W, which are to be connected, or a weld bead on the surface of a workpiece W. The machining device 1 can further also be formed by means of a device for treating the surface of a workpiece W by means of a plasma torch, a varnishing device, a cutting device, and many more (not illustrated). Depending on the machining process, the result of the machining process BP differs along the machining path X.

FIG. 2 shows a schematic illustration of a machining device 1 for performing a method according to the invention for the automatic determination of new machining parameters P″(x) for a machining process BP by taking limit values P_{G}(x) for the machining parameters P(x) into consideration. According to the invention, limit values P_{G}(x) for the machining parameters P(x), for example upper limit values P_{G,o}(x) and lower limit values P_{G,u}(x) are now determined during the machining process BP to be performed, and are stored, for example, in a database 6, and these stored limit values P_{G}(x) are taken into consideration for the machining parameters P(x) when selecting the new machining parameters P″(x) for the machining process BP to be performed. The limit values P_{G}(x) for the machining parameters P(x) can be input, for example, via an input device 7, and can be stored in the database 6. The limit values P_{G}(x) for the machining parameters P(x) can likewise be determined automatically prior to performing the machining process BP, and can preferably be stored, for example by virtually passing through the machining process BP. The limit values P_{G}(x) for the machining parameters P(x) can furthermore also be determined automatically while performing the machining process BP and can possibly be stored. When virtually or computationally passing through the machining process BP, respectively, limit values P_{G}(x), which are caused by clamping devices or the like, are also taken into consideration for the machining parameters P(x), for example.

In addition to the limit values P_{G}(x) for the machining parameters P(x), alternative machining parameters Pₐ(x) can be stored in the database 6 or in a memory at an arbitrary storage location, which parameters are specified and used as new machining parameters P″(x) for the machining process BP in the event a limit value P_{G}(x) for a machining parameter P(x) is approached or reached. The limit values P_{G}(x) are thus taken into consideration in the case of the specified new machining parameters P″(x). If determined limit values P_{G}(x) for the machining parameters P(x) are not reached or approached, the machining process BP is performed by means of the certain machining parameters P′(x), which are selected on the basis of the condition B(x), as new machining parameters (P″(x)) (see FIG. 1).

If the limit values P_{G}(x) are reached or approached, the machining process BP is performed by means of new machining parameters P″(x), which adhere to the limit values P_{G}(x). The new machining parameters (P″(x)) differ from the certain machining parameters (P′(x)) in this case. The new machining parameters (P″(x) are to be understood to be more suitable or optimal by adhering to the limit values P_{G}(x), at least with regard to the machining quality, which is to be attained, during the machining process.

FIG. 3A to 3D show test workpieces 14 comprising test weld seams 13 in various positions with respect to the gravity acceleration vector g for the determination of ideal welding parameters Pᵢ(x). According to FIG. 3A, for example the ideal welding parameters Pᵢ(x) of an overlap seam are detected and stored first in a first position, here in flat position. For this purpose, an expert determines the ideal welding parameters Pᵢ(x) according to the welding task while performing a test welding process. If the welding task is fulfilled satisfactorily, and if an improvement cannot be expected with regard to the result of the welding task by changing the set values, the set values are stored as ideal welding parameters Pᵢ(x) for an overlap seam in the flat position. FIG. 3B shows the flat test workpieces 14 in a further position, the overhead position, FIG. 3C and FIG. 3D show the positions of the test workpieces 14 comprising a test welding path 13, which is tilted by 45° and horizontally arranged, for which the ideal welding parameters Pᵢ(x) are also determined and stored. In the case of the straight test welding paths 13 illustrated here, the direction of the tangential vector t is equal to the direction of the test welding path 13. Ideal welding parameters Pᵢ(x) for different alignments of the test welding path 13 with respect to the gravity acceleration vector g are furthermore detected.

FIG. 4 shows an exemplary embodiment of the specification of new welding parameters as new machining parameters P″(x) by taking limit values P_{G}(x) of the welding speed vₛ during the welding of a workpiece W into consideration. The welding torch 10 is first guided with a welding speed vₛ along the distance A of the machining path in the form of a vertical-down weld, thus a vertical welding path. In the rounding in the region B of the machining path Z, only a lower welding speed vₛ can be performed, i.e. the welding speed vₛ has an upper limit value v_{s,G,o}, which is selected as new target value for the welding speed. Other welding parameters, such as the welding current, the feed speed of the welding wire, etc., are correspondingly adapted in the region B of the machining path X. A reduced welding speed vₛ as new machining parameter P″(x) is thus specified in the region B for the welding process to be performed. As soon as the region C, a horizontally running transverse seam, of the machining path X was reached, the welding process can be continued at a higher welding speed Vₛ and the other corresponding welding parameters again.

Lastly, FIG. 5 shows an exemplary embodiment of the specification of suitable welding parameters by taking limit values of the angle of attack α_{A} of the welding torch 10 to the workpiece W into consideration. Due to geometric conditions of the workpiece W or of the workpieces W, the adherence of the usually certain angle of attack α_{A}′ of the welding torch 10 to the workpiece is not possible. A limit value thus exists for the angle of attack α_{A,G} of the welding torch 10, which is used as new angle of attack α_{A}″ of the welding torch 10 for performing the welding process, so that a touching of the welding torch 10 on the workpiece W is securely prevented.

The present invention provides for an automatic determination of new machining parameters by taking limit values for machining parameters into consideration, which can be input or determined prior to or during the machining process.

1. A method for the automatic determination of machining parameters (P′(x)) for a machining process (BP), in which a machining head (3) is guided along a machining path (X) over at least one workpiece (W) to be machined, and, depending on the respective position (x) along the machining path (X), certain machining parameters (P′(x)) are selected from stored machining parameters (P(x)) on the basis of predefined conditions (B(x)) for machining the at least one workpiece (W), wherein limit values (P_{G}(x)) for the machining parameters (P(x)) are determined during the machining process (BP) to be performed, and new machining parameters (P″(x)) for the machining process (BP) to be performed are specified by taking these limit values (P_{G}(x)) into consideration.

2. The method according to claim 1, wherein prior to the selection of the certain machining parameters (P′(x)) for the machining process (BP) to be performed, ideal machining parameters (Pᵢ(x)) are determined and stored by means of test machining processes on several test workpieces (14) along test machining paths (13), in each case with a certain position and arrangement of the test workpieces (14), and the certain machining parameters (P′(x)) are determined at the respective position (x) along the machining path (X) for the machining process to be performed from the stored ideal machining parameters (Pᵢ(x)) for the certain positions and arrangements of the test workpieces (14).

3. The method according to claim 2, wherein the certain machining parameters (P′(x)) at the respective position (x) along the machining path (X) for the machining process to be performed depending on the current position and arrangement of the at least one workpiece (W) are determined by means of interpolation of the stored ideal machining parameters (Pᵢ(x)).

4. The method according to claim 1, wherein the limit values (P_{G}(x)) for the machining parameters (P(x)) are input and are preferably stored.

5. The method according to claim 1, wherein the limit values (P_{G}(x)) for the machining parameters (P(x)) are determined automatically and are preferably stored prior to performing the machining process (BP), for example by virtually passing through the machining process (BP).

6. The method according to claim 1, wherein the limit values (P_{G}(x)) for the machining parameters (P(x)) are determined automatically and are preferably stored while performing the machining process (BP).

7. The method according to claim 1, wherein in addition to the limit values (P_{G}(x)) for the machining parameters (P(x)), alternative machining parameters (Pₐ(x)) are stored.

8. The method according to claim 1, wherein a warning is output and/or information is stored, respectively, when a certain machining parameter (P′(x)) for the machining process (BP) to be performed approaches a limit value (P_{G}(x)) for the machining parameters (P(x)) or reaches a limit value (P_{G}(x)) for the machining parameters (P(x)).

9. The method according to claim 1, wherein when approaching or reaching at least one limit value (P_{G}(x)) for a machining parameter (P(x)) as certain machining parameter (P′(x)) for the machining process (BP) to be performed, this at least one limit value (P_{G}(x)) is selected for a machining parameter (P(x)) or approached limit value (P_{G}(x)) for a machining parameter (P(x)) or stored alternative machining parameter (Pₐ(x)) as new machining parameter (P″(x)) for the machining process (BP) to be performed.

10. The method according to claim 1, wherein when selecting the certain machining parameters (P′(x)) for the machining process (BP) to be performed, the limit values (P_{G}(x)) for the machining parameters (P(x)) are taken into consideration prior to the machining process (BP).

11. The method according to claim 10, wherein the machining process (BP) to be performed is simulated with the certain machining parameters (P′(x)), and the new machining parameters (P″(x)) are specified for the machining process (BP) to be performed.

12. The method according to claim 1, wherein the limit values (P_{G}(x)) for the machining parameters (P(x)) are taken into consideration during the machining process (BP) when selecting the certain machining parameters (P′(x)) for the machining process (BP) to be performed, and the new machining parameters (P″(x)) for the machining process (BP) to be performed are specified.

13. The method according to claim 10, wherein the machining process (BP) is stopped when the new machining parameters (P″(x)) differ from the certain machining parameters (P′(x)) by a predefined factor (F) and/or by a predefined absolute value, respectively.

14. The method according to claim 13, wherein when the new machining parameters (P″(x)) deviate from the certain machining parameters (P′(x)) by the predefined factor (F) and/or by the predefined absolute value, respectively, a warning is output and/or information is stored, respectively.

15. A device (1) for machining a workpiece (W) by means of a machining head (3) along a machining path (X) with certain machining parameters (P′(x)), which are formed for carrying out the method according to claim 1.
